(19) United States
(12) Patent Application Publication
(10) Pub. No.: US 2026/0039383 A1
(43) Pub. Date: Feb. 5, 2026

(54) HYBRID OPTICAL AND RADIO FREQUENCY PHASED ARRAY ANTENNAS

(71) Applicant: HUAWEI TECHNOLOGIES CO., LTD., SHENZHEN (CN)

(72) Inventor: Peter ASHWOOD-SMITH, Kanata (CA)

(73) Assignee: HUAWEI TECHNOLOGIES CO., LTD., SHENZHEN (CN)

(21) Appl. No.: 18/793,231

(22) Filed: Aug. 2, 2024

(51) Int. Cl. H04B 10/118; G01S 3/46; H01Q 1/28; H01Q 3/36; H04B 7/06; H04B 7/08; H04B 10/112; H04B 10/50

(52) U.S. Cl. CPC H04B 10/118; G01S 3/46; H01Q 1/288; H01Q 3/36; H04B 7/061; H04B 7/084; H04B 10/1121; H04B 10/503; H04B 2210/006

(57) ABSTRACT

Methods and systems for communicating messages through free space are provided. In particular, examples or implementations facilitate communication between moving devices separated by free space. In examples or implementations, a radio-frequency (RF) communication link is first established between the devices. When one device intends to transmit data to another device, the one device, using an RF phased array, determines an angle-of-arrival for RF signals received from the other device. The one device then aims a light source according to the determined angle-of-arrival and transmits the data as an optical signal. In some examples or implementations, the other device at least partly receives, using a light detector, the optical signal and determines an alignment offset from the light detector. The other device then communicates the alignment offset to the one device by a further RF signal so that the alignment can be improved.

### CROSS-REFERENCE TO RELATED APPLICATIONS

This is the first application filed for the present invention.

### FIELD OF THE INVENTION

The present application pertains to communication networks and in particular to methods and systems for free-space communication.

### BACKGROUND

Free-space optical (FSO) communication systems transfer information across distances without the use of a transfer medium such as a wire, optical fiber, or waveguide. The information is encoded into light at a transmitter by using a light source such as a laser, sent to a receiver through the air or vacuum that separates it from the transmitter, and decoded at the receiver by using an optical detector. These systems can provide fast communication but are typically difficult to align when the transmitter and receiver are moving relative to one another, such as in the case of inter-satellite communication. To locate the receiver, the transmitter typically needs to sweep or scan a space around it, which is time and power consuming. Furthermore, because the divergence of lasers is relatively slight, maintaining alignment is also difficult.

Radio-frequency (RF) phased array systems are an alternative to FSO systems. In these systems, an array of antennas that can each produce RF signals is used at the transmitter to transfer information to the receiver. At the transmitter, the RF signals are coordinated such that their wave fronts constructively and destructively interfere to provide a directional beam that can be aimed towards the receiver. A similar array of antennas can be used at the receiver to detect the beam. As in FSO communication, the beam is transmitted through free-space such as air or vacuum. RF phased array communication systems are typically easier to align than FSO systems because the divergence of the beam is much larger. However, communication typically requires more power and the systems do not provide as much bandwidth.

Therefore, there is a need for methods and systems for free-space communication, such as for inter-satellite communication, that obviate or mitigate one or more limitations.

This background information is provided to reveal information believed by the applicant to be of possible relevance to the present invention. No admission is necessarily intended, nor should be construed, that any of the preceding information constitutes prior art against the present invention.

### SUMMARY

An object of examples or implementations of the present disclosure is to provide methods and systems for free-space communication.

A first aspect of the present disclosure is to provide a method comprising: receiving, by a radio frequency (RF) antenna unit of a first electronic device (FED), a RF signal from a second electronic device (SED), with the RF signal having associated thereto an angle of arrival (AOA) at the FED; aiming a light source of the FED towards the SED in accordance with the AOA of the RF signal; and transmitting, by the light source, an optical signal towards the SED, the optical signal encoding a data message.

In some examples or implementations of the first aspect, the FED may have a control unit, and the method may further comprise determining, by the control unit, the AOA. In some of these examples or implementations, the RF antenna unit may include a plurality of antennae arranged as an array of antennae. In these examples or implementations, receiving, by the RF antenna unit of the FED, the RF signal from the SED may include receiving, by each antenna of the array of antennae, the RF signal, the RF signal having a respective phase shift at each antenna. Furthermore, in these examples or implementations, determining, by the control unit, the AOA may include determining, by the control unit, the AOA in accordance with the respective phase shift of each antenna of the array of antennae. In some other embodiments or implementations, determining, by the control unit, the AOA may include determining, by the control unit, the AOA in accordance with a multiple signal classification algorithm.

In some examples or implementations of the first aspect, the method may further comprise establishing, by the RF antenna unit, a RF link with the SED.

In some examples or implementations or implementations of the first aspect, the method may further comprise: receiving, by the RF antenna unit, a further RF signal from the SED, the further RF signal defining an alignment offset; re-aiming the light source towards the SED in accordance with the alignment offset; and transmitting, by the light source, a further optical signal towards the SED, the further optical signal encoding the data message.

In some examples or implementations of the first aspect transmitting, by the light source, the optical signal towards the receiving electronic device may include sweeping the light source through a sweep pattern oriented in accordance with the AOA of the RF signal.

In some examples or implementations of the first aspect, the light source may be a free-space laser. In some examples or implementations, at least one of the SED and the FED may be a satellite.

In some examples or implementations of the first aspect, each of the light source and the RF antenna unit may be co-located at the FED.

A second aspect of the present disclosure is to provide a method comprising: receiving, by a light detector of a FED, an optical signal from a SED, with the optical signal encoding a data message and having associated thereto a first detected power and an alignment offset; transmitting, by a RF antenna unit of the FED, a RF signal towards the SED, the RF signal encoding the alignment offset; and receiving, by the light detector, a further optical signal from the SED, the further optical signal encoding the data message and having associated thereto a second detected power being greater than the first detected power.

In some examples or implementations of the second aspect, the method may further comprise establishing, by the RF antenna unit, a RF link with the SED.

In some examples or implementations of the second aspect, the light detector may include a main light sensor and one or more auxiliary light sensors each separated from the main light sensor. In these examples or implementations, receiving, by the light detector, the optical signal from the SED may include: receiving, by the main light sensor, a main light sensor portion of the optical signal having a respective optical power; and receiving, by each of the one or more auxiliary light sensors, a respective auxiliary light sensor portion of the optical signal having a respective auxiliary optical power. In some of these examples or implementations, the FED may have a control unit, and the method may further comprise determining, by the control unit, the alignment offset in accordance with the respective optical power of the main light sensor portion of the optical signal and the respective auxiliary optical power of each auxiliary light sensor portion of the optical signal. In some examples or implementations, the main light sensor may be located about at a first predetermined vector with respect to the RF antenna unit and each of the one or more auxiliary light sensors is located about at a respective second predetermined vector with respect to the main light sensor.

In some examples or implementations of the second aspect, at least one of the FED and the SED is a satellite.

A third aspect of the present disclosure is to provide a system for communicating a data message comprising a FED and a SED. The SED may have a light source and a respective RF antenna unit. The SED may be configured to: receive, by the respective RF antenna unit, a RF signal from the FED, the RF signal having associated thereto an angle of arrival (AOA) at the SED; aim the light source towards the FED in accordance with the AOA of the RF signal; and transmit, by the light source, an optical signal towards the FED, the optical signal encoding the data message.

In some examples or implementations of the third aspect, the FED may have a light detector and a respective RF antenna unit. In these examples or implementations, the FED may be configured to: receive, by the light detector, the optical signal from the SED, the optical signal having associated thereto an alignment offset; and transmit, by the respective RF antenna unit, a further RF signal towards the SED, the RF signal encoding the alignment offset. In some of these examples or implementations, the SED may be further configured to: receive, by the respective RF antenna unit, the further RF signal from the FED; re-aim the light source towards the FED in accordance with the alignment offset; and transmit, by the light source, a further optical signal towards the FED, the further optical signal encoding the data message. In some further examples or implementations, the FED may be further configured to: receive, by the light detector, the further optical signal from the SED, the further optical signal having associated thereto a respective detected power being greater than the respective detected power of the optical signal.

Examples or implementations of the present disclosure may facilitate free-space communication. Examples or implementations may enable time-and power-efficient aligning of a free-space optical communication system informed by RF signalling. RF signalling may further enable continuous fine-tuning of the alignment of the system as well. The hybrid optical-RF communication systems of the present disclosure may provide fast, directional communication links and may further enable communication between moving electronic devices.

Examples or implementations have been described above in conjunctions with aspects of the present invention upon which they can be implemented. Those skilled in the art will appreciate that examples or implementations may be implemented in conjunction with the aspect with which they are described, but may also be implemented with other examples or implementations of that aspect. When examples or implementations are mutually exclusive, or are otherwise incompatible with each other, it will be apparent to those skilled in the art. Some examples or implementations may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1A shows a schematic for an example of free-space optical (FSO) communication.

FIG. 1B shows a schematic for an example of divergence in FSO communication.

FIG. 2A shows a schematic for an example of a radio-frequency (RF) transmitter.

FIG. 2B shows a schematic for an example of a RF receiver.

FIG. 3A shows a schematic for a transmitter according to an example or implementation of the present disclosure.

FIG. 3B shows a schematic for a receiver according to an example or implementation of the present disclosure.

FIG. 4 shows a call-flow for transmitting a data message according to an example or implementation of the present disclosure.

FIG. 5A shows a flowchart of a method for transmitting a data message according to an example or implementation of the present disclosure.

FIG. 5B shows a flowchart of a method for receiving a data message according to an example or implementation of the present disclosure.

FIG. 6A shows inter-satellite communication in accordance with an example or implementation of the present disclosure.

FIG. 6B shows communication between a satellite and ground terminal in accordance with an example or implementation of the present disclosure.

FIG. 7 shows a schematic of an apparatus for hybrid optical-RF communication according to examples or implementations of the present disclosure.

FIG. 8 shows a schematic of an example of an electronic device that may implement at least part of the methods and features of the present disclosure.

It will be noted that throughout the appended drawings, like features are identified by like reference numerals.

### DETAILED DESCRIPTION

Examples or implementations of the present disclosure are generally directed towards combining free-space optical (FSO) communication with radio-frequency (RF) communication to provide a hybrid form of communication. In particular, examples or implementations may provide methods for communication between entities that are moving with respect to one another. In examples or implementations, to communicate a data message from a transmitter to a receiver, an RF link may be first established between them using respective RF antenna units. The transmitter may then transmit, by a FSO light source, the data message as an optical signal towards the receiver. The FSO light source may be aimed towards the receiver by determining the angle-of-arrival (AOA) for RF signals received at the transmitter when sent through the RF link. In some examples or implementations, when transmitting the optical signal, the FSO light source may sweep an area around the AOA. In some examples or implementations, when the optical signal is received by the receiver, the optical signal may be received misaligned to a light detector at the receiver. The receiver may determine an alignment adjustment and send a RF signal to the transmitter that communicates the alignment adjustment. The transmitter may then adjust the aim of the FSO light source according to the alignment adjustment and re-transmit the data message to the receiver. In some examples or implementations, this feedback process may be performed iteratively to fine tune the alignment of the FSO light source.

The present disclosure sets forth various examples or implementations via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. The terms in each of the following sets may be considered interchangeable throughout the disclosure: “laser” and “light source”; “offset” and “alignment adjustment”; and “RF antenna unit” and “RF antenna array”.

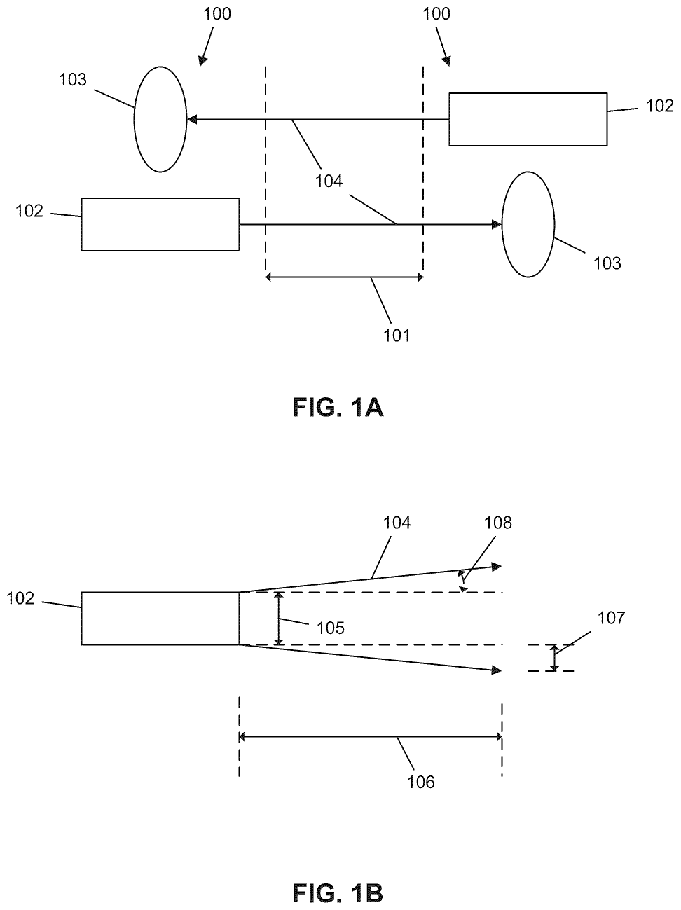

FIG. 1A shows a schematic for an example of FSO communication. Two electronic devices 100 are separated by free space 101 and each have a respective light source 102 and a respective light detector 103. For one electronic device 100 to communicate with the other electronic device 100, the one electronic device 100 may send an optical signal 104 by its respective light source. The other electronic device 100 may then receive the optical signal 104 by its respective light detector 103. The free space 101 may, for example, be vacuum, atmosphere, air, or another minimally dispersive medium. Each light source 102 may, for example, be a laser, especially a high-power free-space laser with an operating wavelength in the infrared (i.e., 700 nm to 100 μm), the visible (i.e., 400 nm to 700 nm), or ultraviolet (i.e., 100 to 400 nm). To form the optical signal 104, the data message may be encoded in light emitted by the transmitting laser by either directly modulating it or by an optical modulator accompanying it. For example, the intensity of the laser may be modulated to encode the data message. Each light source 102 may be aimed towards the opposing light detector 103 through means such as optics components, electromechanical motors, nanoantennae, and/or other suitable technologies for beam steering. Each light detector 103 may, for example, be a photodiode, photoconductor, photomultiplier tube, or other light sensor. The data message may be decoded from the optical signal 104 by, for example, monitoring the optical power received by the receiving light detector 103.

FIG. 1B shows an example of typical divergence for an optical signal 104 generated by a light source 102, namely a laser, in FSO communication. The light source 102 has an aperture 105 from which the optical signal 104 is emitted into free space 101. At a distance 106 from the aperture 105, the optical signal 104 may have spatially broadened to a corresponding divergence 107. The broadening of the optical signal 104 beyond the area of the aperture 105 may be characterized by a divergence angle 108. Table 1 provides the divergence 107 that may be expected at a distance 106 of 500 km for different operating wavelengths for a light source 102 with an aperture 105 of 50 cm.

TABLE 1
Typical divergence for FSO communication.

| Wavelength | Aperture | Divergence | Distance from | Divergence |
|---|---|---|---|---|
| (μm) | (cm) | Angle (deg.) | Aperture (km) | (cm) |
| 0.001 | 50 | 3.648 × 10⁻⁸ | 500 | 0.06366 |
| 0.01 | 50 | 3.648 × 10⁻⁷ | 500 | 0.6366 |
| 0.1 | 50 | 3.648 × 10⁻⁶ | 500 | 6.366 |
| 1 | 50 | 3.648 × 10⁻⁵ | 500 | 63.66 |
| 10 | 50 | 3.648 × 10⁻⁴ | 500 | 636.6 |
| 100 | 50 | 3.648 × 10⁻³ | 500 | 6366 |

The divergence 107 of optical signals 104 can be relatively small, even at distances 106 of thousands of kilometers. Because of this narrow divergence, individual FSO communication systems can have a minimal likelihood of interfering with other communication systems and typically do not require licensing of particular operating wavelengths (or frequencies). However, the narrow divergence typically requires precise aiming of the respective light source 102 at one electronic device 100 towards the respective light detector 103 at the other electronic device 100. Unless the exact location of the other electronic device 100 is known, the one electronic device 100 typically needs to broadly sweep its light source 102 through space to find its target. Furthermore, to confirm correct aiming and alignment, the other electronic device 100 typically needs its respective light source 102 also precisely aimed towards the respective light detector 103 at the one electronic device 100. The scanning of space needed to align the two electronic devices 100 is typically energy and time consuming.

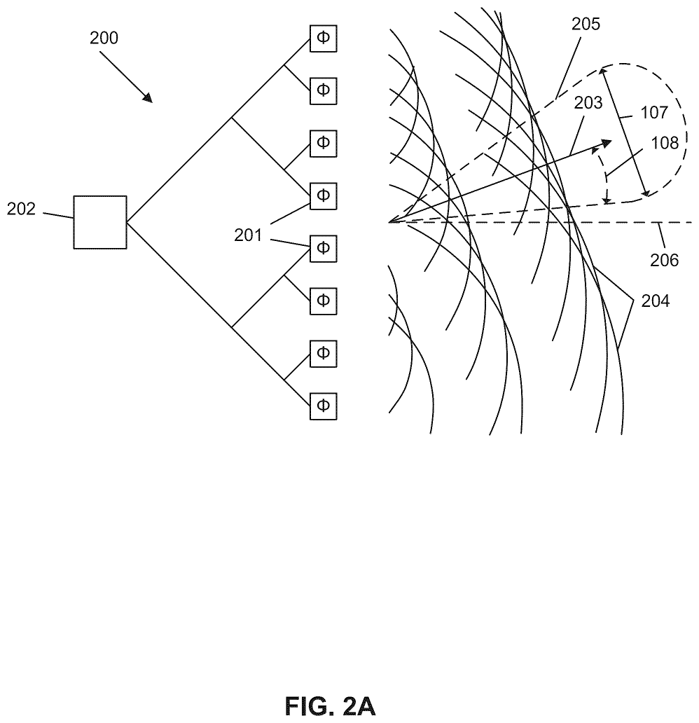

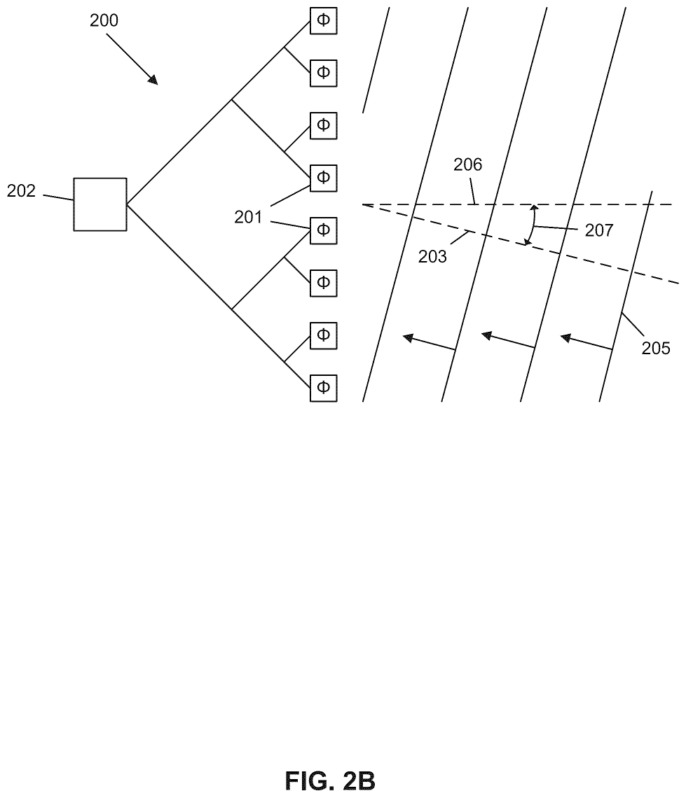

FIG. 2A shows a schematic for an example of RF phased array communication. Here, an RF antenna unit 200 includes an array of RF antennae 201 (i.e., a phase array) and a control unit 202. The array of RF antennae 201 may be arranged in a one-dimensional line or two-dimensional plane. Each RF antenna 201 may be communicatively coupled with the control unit 202. To transmit a data message in a particular direction 203, each RF antenna may generate a respective RF signal (shown as wavefronts 204 in FIG. 2A) encoding the data message, with each RF signal having a respective phase shift Φ. Each RF signal generated by a RF antenna 201 may constructively or destructively interfere with each other RF signal to produce a singular RF signal 205 propagating towards the particular direction 203. The control unit 202 may coordinate the array of RF antennae 201 so that each RF antenna 201 has the desired respective phase shift. The RF signal 205 produced by the array of RF antennae 201 may manifest as a lobe having a divergence 107 about the particular direction 203. The particular direction 203 may be characterized by an angle relative to a boroscope 206 of the array of RF antennae 201, which may be the direction that is perpendicular to the array. When the particular direction 203 aligns with the boroscope 206, each RF antenna 201 may have zero phase shift. The divergence 107 may be characterized by a divergence angle 108, relative to the particular direction 203. The divergence angle 108 may depend on the operating wavelength of the RF antennae 201 and the particular direction 203. Table 2 provides the divergence 107 that may be expected at a distance 106 of 500 km for different operating wavelengths for a RF signal 205 generated by a RF antenna unit 200 including a 24×24 array of RF antennae 201.

TABLE 2
Typical divergence for RF phase array communication.

| | | Divergence | Distance | Divergence | Divergence |
|---|---|---|---|---|---|
| | | Angle (aimed | from | (aimed along | (aimed 60 deg. |
| Wavelength | Frequency | along boroscope, | Array | boroscope, | from |
| (mm) | (GHz) | deg.) | (km) | km) | boroscope, km) |
| 23.53 | 12.75 | 4.250 | 500 | 74.11 | 146.2 |
| 20.69 | 14.50 | 4.230 | 500 | 73.76 | 145.5 |

An RF antenna unit 200 may also be used to receive a data message encoded in an RF signal 205. The RF antenna unit 200 may further be capable of detecting the direction from which the RF signal 205 was received. FIG. 2B shows a schematic of an example for determining the AOA 207 of an RF signal 205. Here, the RF signal 205 (shown as aggregate wavefronts) approaches the RF antenna unit 200 from a particular direction 203. The RF signal 205 may be received at each RF antenna 201 with a respective phase shift (i.e., a respective time of arrival). The control unit 202 may record the different phase shifts and use them to determine the AOA 207 for the RF signal 205. The AOA 207 may be defined relative to the boroscope 206 (or bullseye) of the RF antenna unit 200 and may include an azimuthal component and an elevation component.

The divergence 107 for RF phased array communication is relatively large, typically several orders of magnitude greater than that for FSO communication. Because of the large divergence 107, RF phased array communication systems are typically straightforward to align. However, the large divergence 107 can cause the energy of transmissions to be dispersed over large areas, which wastes power and can cause interference in other communication systems.

Examples or implementations of the present disclosure are generally directed towards using RF antenna units 200 to align light sources 102 for communication between electronic devices 100. Examples or implementations may facilitate faster and more efficient aiming of FSO communication systems, especially for those between moving transmitters and receivers such as artificial satellites.

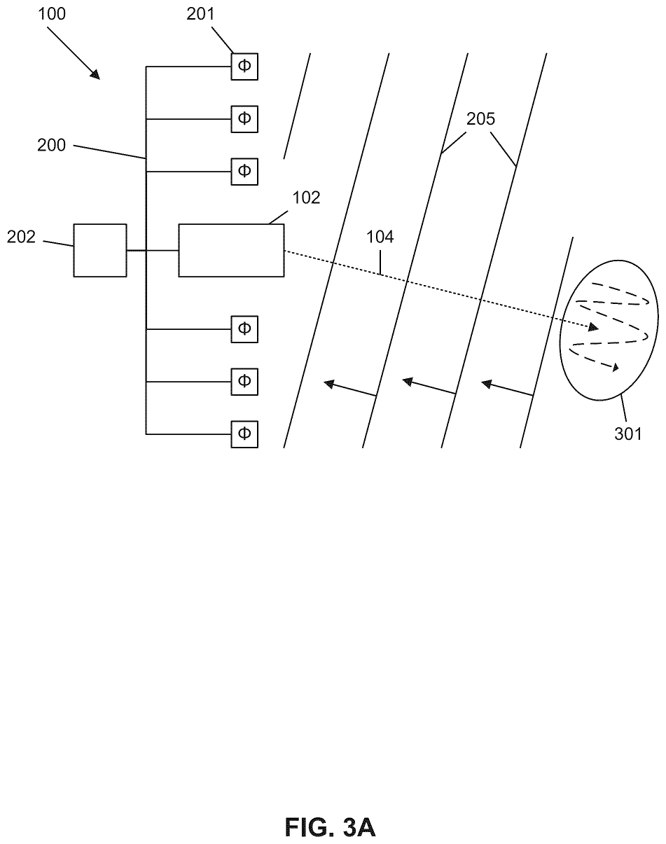

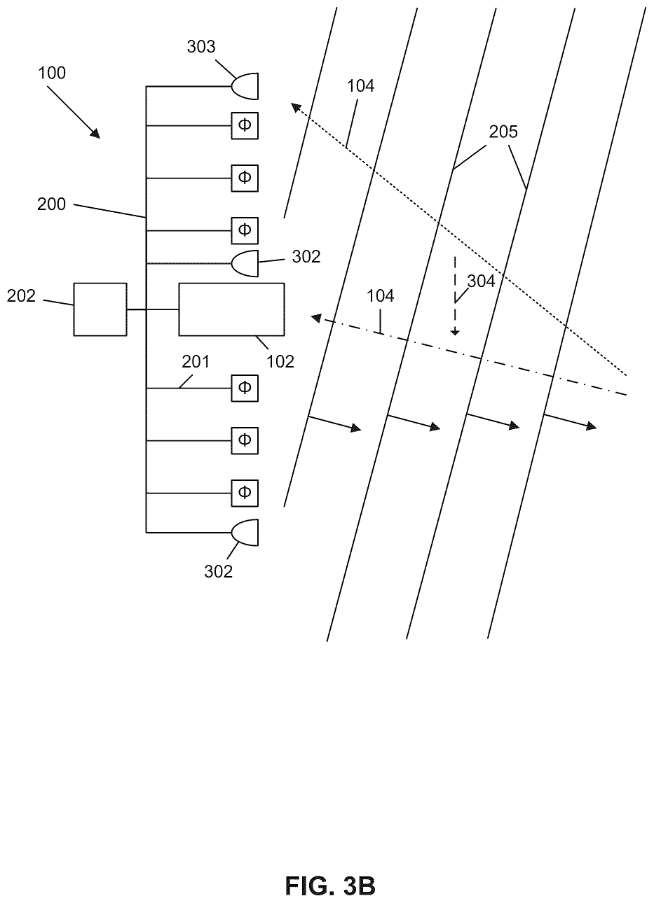

FIG. 3A shows a schematic of an electronic device 100 (i.e., a “transmitter”) for transmitting a data message, in accordance with an example or implementation of the present disclosure. The transmitter includes a RF antenna unit 200, a light source 102, and a control unit 202. The RF antenna unit 200 may include an array of RF antennae 201 (i.e., a phase array). The array of RF antennae 201 may be arranged in a one-dimensional line or two-dimensional plane. Each RF antenna 201 and the light source 102 may be communicatively coupled with the control unit 201. The light source 102 may be co-located with the RF antenna unit 200 and may further be located between RF antennae 201 of the array of RF antennae 201, such as at the center or the periphery of the array of RF antennae 201. The light source 102 may also be located at any other position indicated by a known vector with respect to the array of RF antennae 201. Alternatively, the light source 102 may have a known position relative to the RF antenna unit 200. The light source 102 may, for example, be a laser, especially a high-power free-space laser with an operating wavelength in the infrared (i.e., 700 nm to 100 μm), the visible (i.e., 400 nm to 700 nm), or ultraviolet (i.e., 100 to 400 nm). The light source 102 may be configured to encode the data message in light as an optical signal 104. Encoding may be done by either directly modulating the light source 102 or by an optical modulator accompanying it. For example, the intensity of the light source 102 may be modulated to encode the data message. The transmitter may, for example, belong to a satellite, a vehicle such as a plane or a boat, or other moving machine. Alternatively, the transmitter may be located at a fixed ground-based communication node.

To transmit the data message to another electronic device 100 (i.e., the “receiver”) through free space 101, the transmitter may first determine a direction towards which an optical signal 104 encoding the data message should be sent. In other words, the transmitter may first determine the direction towards the receiver. This may be done in accordance with an RF signal 205 received at the transmitter from the receiver. The RF signal 205 may be received at each RF antenna 201 of the RF antenna unit 200 with a respective phase shift (i.e., a respective time of arrival), as described above in relation to FIG. 2B. The control unit 202 may record the different phase shifts and use them to determine the AOA 207 for the RF signal 205. The AOA 207 may be defined relative to the boroscope 206 (or bullseye) of the RF antenna unit 200 and may include an azimuthal component and an elevation component. Determining the AOA 207 may include using an algorithm such as a Multiple Signal Classification (MUSIC) algorithm. Prior to receiving the RF signal 205, the transmitter may establish a RF link with the receiver. The RF link may be established by a discovery-response method, according to known positions or movement schedules, or by other suitable methods known to a person of skill in the art.

Once the AOA 207 is determined by the transmitter, it may aim its light source 102 according to the AOA 207, such that the light source 102 is approximately pointed towards the receiver. The light source 102 may be aimed through means such as optics components, electromechanical motors, nanoantennas, and/or other suitable technologies for beam steering. The transmitter may then transmit the data message as an optical signal 104 emitted by the light source 102 (shown by dotted arrow). Transmitting the optical signal 104 may include sweeping the light source 102 through a sweep pattern 301 (shown by dashed arrow). The sweep pattern may be oriented about the direction towards the receiver. Sweeping the light source 102 may include moving the aim of the light source 102 to scan or raster a solid angle of space. The data message may be repetitiously transmitted optical signals 104 that are emitted as the light source 102 is swept.

FIG. 3B shows a schematic of an electronic device 100 (i.e., a “receiver”) for receiving a data message, in accordance with an example or implementation of the present disclosure. The receiver includes a RF antenna unit 200, a light source 102, a control unit 202, and a light detector 103. The RF antenna unit 200 may include an array of RF antennae 201 (i.e., a phase array). The array of RF antennae 201 may be arranged in a one-dimensional line or two-dimensional plane. The light detector 103 may include a main light sensor 302 and one or more auxiliary light sensors 303. The main light sensor 302 may be located at a predetermined, or known, location indicated by a known vector with respect to the RF antenna unit 200. In some examples or implementations, the main light sensor 302 may be co-located with the RF antenna unit 200 and may further be located between RF antennae 201 of the RF antenna unit 200, such as at the center of the RF antenna unit 200, or at the periphery of the RF antenna unit 201. Each auxiliary light sensor 303 may be separated from the main light sensor 302 and may further be located at a respective predetermined location indicated by a known vector with respect to the main light sensor 302. For example, when the main light sensor 302 is located at a center of the RF antenna unit 200, each auxiliary light sensor 303 may be located at a respective peripheral position about the RF antenna unit 200. Alternatively, the one or more auxiliary light sensors 303 may be co-located or arranged as an array about the main light sensor 302. Each of the main light sensor 302 and the one or more auxiliary light sensors 303 may, for example, be a photodiode, photoconductor, photomultiplier tube, or other light sensor. Each of the main light sensor 302 and the one or more auxiliary light sensors 303 may be sensitive to a particular bandwidth of light or may be broadband, and may further be configured to detect an optical signal 104. For example, each of the main light sensor 302 and the one or more auxiliary light sensors 303 may be configured to detect and decode an optical signal 104 by monitoring received optical power over time. Each RF antenna 201, the light source 102, and the light detector 103 may be communicatively coupled with the control unit 202. The receiver may, for example, belong to a satellite, a vehicle such as a plane or a boat, or other moving machine. Alternatively, the receiver may be located at a fixed ground-based communication node.

When an optical signal 104 encoding a data message (indicated by dotted arrow) arrives at the receiver from a transmitter, it may arrive misaligned with the main light sensor 302. In other words, the main light sensor 302 may receive a portion of the optical signal 104 (i.e., a “main light sensor portion”) that has a respective optical power and each of the one or more auxiliary light sensors 303 may receive a respective portion of the optical signal 104 (i.e., “respective auxiliary light sensor portions”). For example, the optical signal 104 may arrive with more power sent to one of the of the one or more auxiliary light sensors 303 than the main light sensor 302. The control unit 202 may record the optical power received by each of the main light sensor 302 and the one or more auxiliary light sensors 303 and determine an alignment offset 304 accordingly. The alignment offset 304 may include multiple directional components, such as a vertical offset (y) and a horizontal offset (x).

The receiver may communicate the alignment offset 304 to the transmitter so that the transmitter may adjust its aim for sending optical signals 104. The receiver may transmit the alignment offset 304 to the transmitter as a RF signal 205 generated by its RF antenna unit 200. Prior to transmitting the RF signal 205, the receiver may establish a RF link with the transmitter. The RF link may be established by a discovery-response method, according to known positions or movement schedules, or by other suitable methods known to a person of skill in the art. The RF link may further have been established prior to receiving the optical signal 104.

The transmitter may receive the RF signal 205 encoding the alignment offset 304 and may re-aim its light source 102 accordingly. The transmitter may then transmit the data message again to the receiver by a further optical signal 104. This may include sweeping the light source 102 through a sweep pattern 301, as described in relation to FIG. 3A. The further optical signal 104 (shown by the dot-dash arrow in FIG. 3B) may be received at the receiver with more power directed towards the main light sensor 302. In other words, the detected power of the further optical signal 104 may be greater than the detected power of the initial optical signal 104. Iterations of determining an alignment offset 304 at the receiver, communicating the alignment offset 304 to the transmitter by an RF signal 205, adjusting the aim of the light source 102 at the transmitter, and transmitting a further optical signal 104 may be performed to further improve the alignment between the transmitter and receiver.

In some examples or implementations of the present disclosure, each of the transmitter and receiver may be electronic devices 100 that are likewise configured, with each including a respective RF antenna unit 200, control unit 202, light source 102, and light detector 103. Each of the transmitter and receiver may be configured to transmit and receive both of optical signals 104 and RF signals 205, such that each may be considered a transceiver. In this case, data messages may be sent in either direction between each of the electronic devices 100.

In some examples or implementations, the alignment between two electronic devices 100 may be stabilized and optical signals 104 may be freely transmitted between them without further feedback on alignment as communicated by RF signals 205. In some examples or implementations, the RF link may be, at least temporarily, powered down once FSO communication is stabilized. In some examples or implementations, alignment feedback may be periodically communicated by RF signals 205.

In some examples or implementations of the present disclosure, data messages may be inverse multiplexed between the channels for RF signals 205 and optical signals 104.

In some examples or implementations, information encoded in the RF signals 205 or optical signals 104 may be used to additionally adjust the position or orientation of one of the electronic devices 100.

Communication according to examples or implementations of the present disclosure, such as that described in relation to FIGS. 3A and 3B, may be referred to as hybrid optical-RF communication.

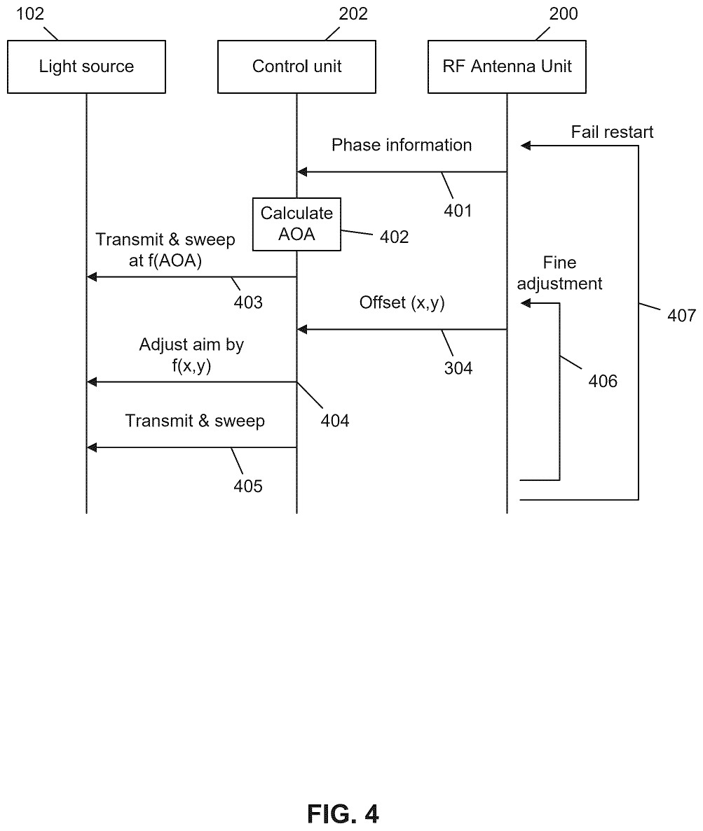

FIG. 4 shows a call-flow for a transmitter for sending a data message by hybrid optical-RF communication to a receiver, in accordance with examples or implementations of the present disclosure. The transmitter includes an RF antenna unit 200, a light source 102, and a control unit 202, which may be configured according to FIG. 3A. The RF antenna unit 200 receives a RF signal 205 from the receiver and provides to the control unit 202 information 401 on the respective phase shift of the RF signal 205 at each RF antenna 201 of the RF antenna unit 200. The control unit 202 may then calculate 402 the AOA of the RF signal 205 in accordance with the information 401 received from the RF antenna unit 200. The control unit 202 may then direct 403 the light source 102 to be aimed according to the calculated AOA and to transmit the data message as an optical signal 104, which may include being directed to sweep through a sweep pattern 301. After sending the optical signal 104, the transmitter may receive, by the RF antenna unit 200, a further RF signal 205 from the receiver, which may define an alignment offset 304 (x, y). The RF antenna unit 200 may provide the alignment offset 304 to the control unit 202, which may then direct the light source 102 to adjust 404 its aim according to a function of the alignment offset 304 (f(x, y)). After adjusting its aim, the light source 102 may be directed 405 by the control unit 202 to transmit the data message again as a further optical signal 104. RF antenna unit 200 may again receive a RF signal 205 from the receiver with a further alignment offset 304 for further fine adjustment 406. In some cases, if one optical signal 104 fails to be received by the receiver, the call-flow may restart 407.

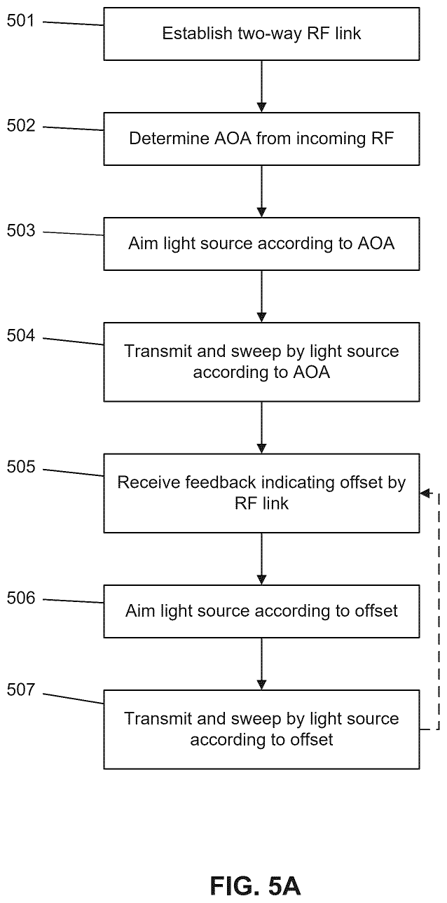

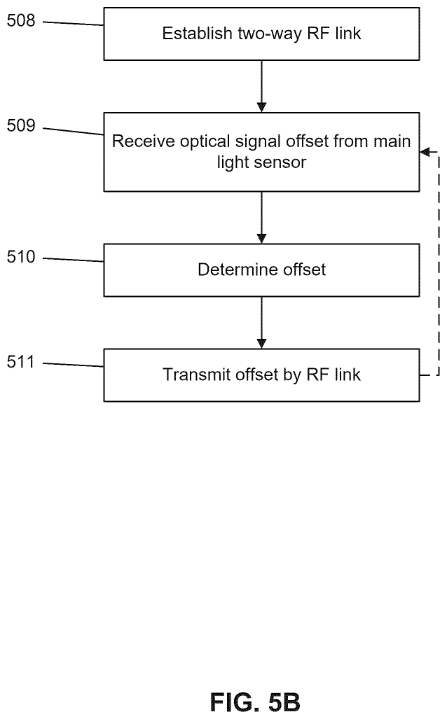

FIG. 5A shows a flowchart for a method for a transmitter for sending a data message by hybrid optical-RF communication to a receiver, in accordance with examples or implementations of the present disclosure. The transmitter may include an RF antenna unit 200, a light source 102, and a control unit 202, each of which may be configured according to FIG. 3A. At action 501, the transmitter may establish a two-way RF link with the receiver. The transmitter may receive RF signals 205 from the receiver through the RF link. At action 502, the transmitter may determine, for a RF signal 205 received by the RF link, an AOA. At action 503, the transmitter may aim its light source 102 towards the receiver according to the AOA determined for the RF signal 205. At action 504, the transmitter may transmit, by the light source 102, an optical signal 104 encoding the data message. This may include sweeping the light source 102 through a sweep pattern 301 oriented according to the AOA. At action 505, the transmitter may receive, from the receiver, feedback in the form of a further RF signal 205 defining an alignment offset 304. At action 506, the transmitter may re-aim the light source 102 towards the receiver in accordance with the alignment offset 304. At action 507, the transmitter may transmit, by the light source 102, a further optical signal 104 encoding the data message. This may include sweeping the light source 102 through a sweep pattern 301 oriented according to the offset. Actions 505 to 507 may repeat to further fine tune the alignment of the transmitter with the receiver.

FIG. 5B shows a flowchart for a method for a receiver for receiving a data message by hybrid optical-RF communication from a transmitter, in accordance with examples or implementations of the present disclosure. The receiver may include an RF antenna unit 200, a light detector 103, and a control unit 202, each of which may be configured according to FIG. 3B. At action 508, the receiver may establish a two-way communication link with the transmitter. The receiver may transmit RF signals 205 to the transmitter through the RF link. At action 509, the receiver may receive, by its light detector 103, an optical signal 104 from the transmitter. The optical signal 104 may encode the data message and have associated with it an initial detected power and an alignment offset 304. The initial detected power may, for example, be the optical power received at a main light sensor 302 of the light detector 103. At action 510, the receiver may determine the alignment offset 304, such as by comparing the optical power received by a main light sensor 302 and one or more auxiliary light sensors 303. At action 511, the receiver may transmit, by its RF antenna unit 200, a RF signal 205 to the transmitter that encodes the alignment offset 304. Actions 509 to 511 may repeat, with the detected power of each successive optical signal 104 increasing as the alignment between the transmitter and receiver improves.

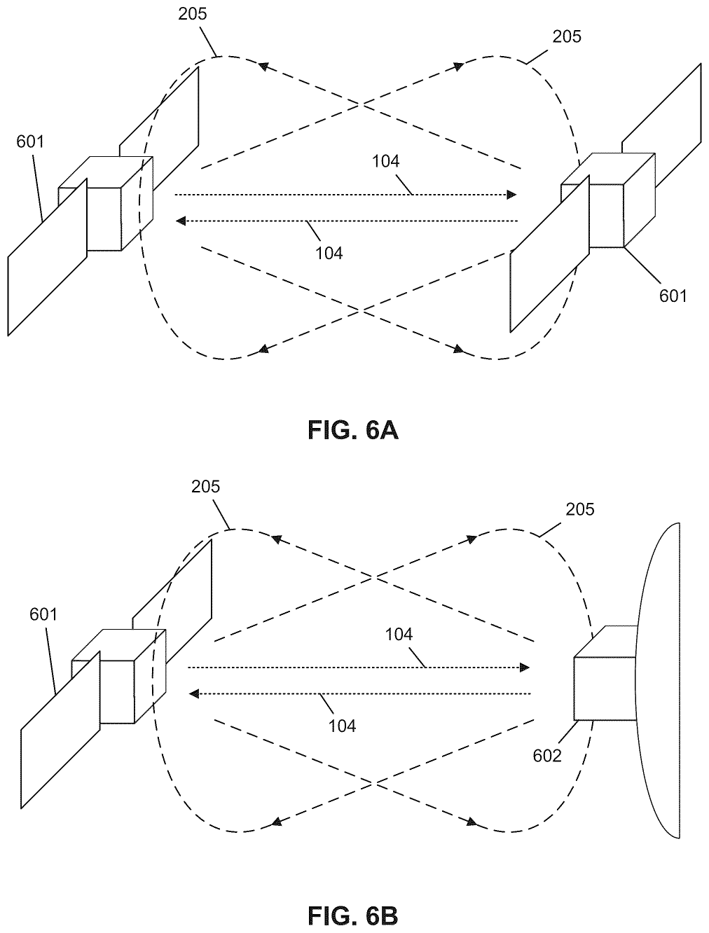

FIG. 6A shows hybrid optical-RF communication in accordance with an example or implementation of the present disclosure. Here, hybrid optical-RF communication is enabling an inter-satellite communication link between two artificial satellites 601. The satellites 601 may be in space and separated by vacuum. The satellites 601 may further be moving relative to one another; for example, each satellite 601 may be in a different orbit about an astronomical body. Each satellite 601 is configured as a respective electronic device 100 that includes a RF antenna unit 200, a light source 102, a light detector 103, and a control unit 202. Each satellite 601 is further configured to perform both of the methods described in relation to FIGS. 5A and 5B, for transmitting and receiving data messages, respectively. Accordingly, FIG. 6A shows optical signals 104 (indicated by dotted arrows) and RF signals 205 (indicated by dashed arrows) being sent from each of the satellites 601.

FIG. 6B shows hybrid optical-RF communication in accordance with another example or implementation of the present disclosure. Here, hybrid optical-RF communication is enabling communication between an artificial satellite 601 and a ground terminal 602. The ground terminal 602 may have a fixed position on an astronomical body such as Earth. In contrast, the satellite 601 may be in space and separated from the ground terminal 602 by vacuum and atmosphere. The satellite 601 may further be moving relative to the ground terminal 602; for example, the satellite 601 may be in an orbit about the astronomical body that the ground terminal 602 is fixed to. Each of the satellite 601 and ground terminal 602 is configured as a respective electronic device 100 that includes a RF antenna unit 200, a light source 102, a light detector 103, and a control unit 202. Each of the satellite 601 and the ground terminal 602 is further configured to perform both of the methods described in relation to FIGS. 5A and 5B, for transmitting and receiving data messages, respectively. Accordingly, FIG. 6B shows optical signals 104 (indicated by dotted arrows) and RF signals 205 (indicated by dashed arrows) being sent from each of the satellite 601 and the ground terminal 602.

Examples or implementations of the present disclosure may be implemented using electronics hardware, software, or a combination thereof. In some examples or implementations, the invention may be implemented by one or multiple computer processors executing program instructions stored in memory. In some examples or implementations, the invention may be implemented partially or fully in hardware, for example using one or more field programmable gate arrays (FPGAs) or application specific integrated circuits (ASICs) to rapidly perform processing operations.

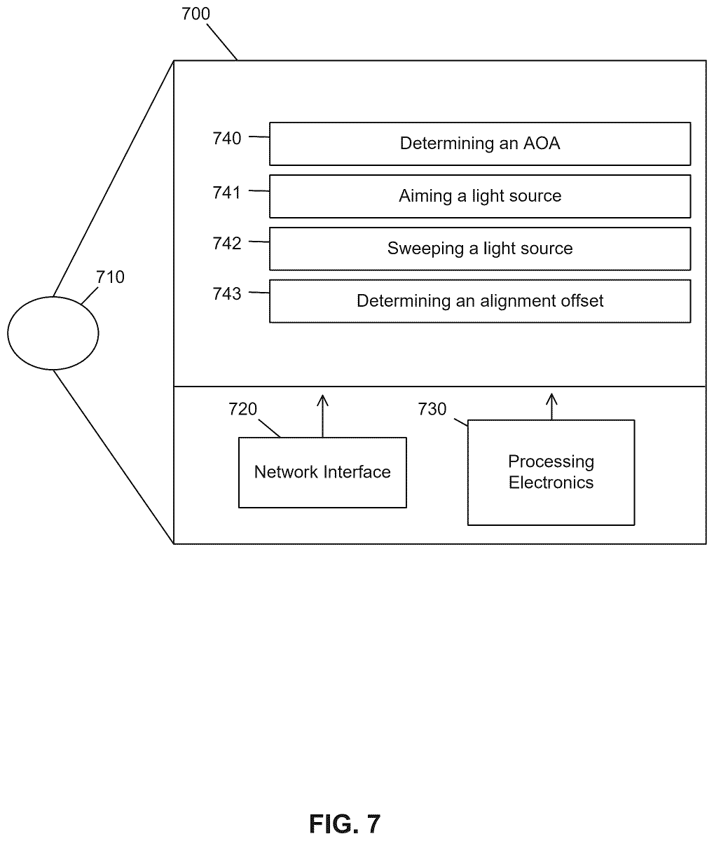

FIG. 7 shows an apparatus 700 for hybrid optical-RF communication, according to examples or implementations of the present disclosure. The apparatus 700 may be located at a node 710 of the network, such as a satellite 601 or ground terminal 602. The apparatus may include a network interface 720 and processing electronics 730. The processing electronics 730 may include a computer processor executing program instructions stored in memory, or other electronics components such as digital circuitry, including for example FPGAs and ASICs. The network interface 720 may include an optical communication interface or radio communication interface, such as a light source 102 and light detector 103 and/or a RF antenna unit 200. The apparatus 700 may include several functional components, each of which may be partially or fully implemented using the underlying network interface 720 and processing electronics 730. Examples of functional components may include modules for determining 740 an AOA, aiming 741 a light source, sweeping 742 a light source, and determining 743 an alignment offset.

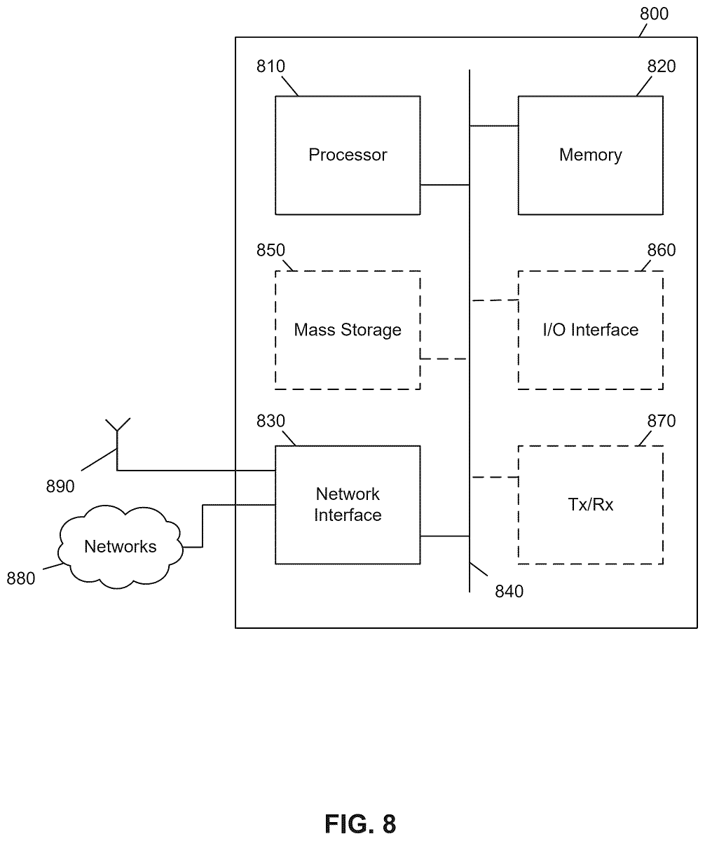

FIG. 8 shows a schematic diagram of an electronic device 800 that may perform any or all of the operations of the above methods and features explicitly or implicitly described herein, according to different examples or implementations of the present disclosure. For example, a computer equipped with network function may be configured as electronic device 800. The electronic device 800 may be used to implement the apparatus 700 of FIG. 7, for example. The electronic device 800 may further be used as part of the electronic devices 100 described in relation to FIGS. 3A and 3B, for example. The electronic device 800 may further be configured to implement a control unit 202.

As shown, the electronic device 800 may include a processor 810, such as a Central Processing Unit (CPU) or specialized processors such as a Graphics Processing Unit (GPU) or other such processor unit, memory 820, network interface 830, and a bi-directional bus 840 to communicatively couple the components of electronic device 800. Electronic device 800 may also optionally include non-transitory mass storage 850, an I/O interface 860, and a transceiver 870. According to certain examples or implementations, any or all of the depicted elements may be utilized, or only a subset of the elements. Further, the electronic device 800 may contain multiple instances of certain elements, such as multiple processors, memories, or transceivers. Also, elements of the hardware device may be directly coupled to other elements without the bi-directional bus 840. Additionally or alternatively to a processor and memory, other electronics, such as integrated circuits, may be employed for performing the required logical operations.

The memory 820 may include any type of tangible, non-transitory memory such as static random access memory (SRAM), dynamic random access memory (DRAM), synchronous DRAM (SDRAM), read-only memory (ROM), any combination of such, or the like. The mass storage element 850 may include any type of tangible, non-transitory storage device, such as a solid state drive, hard disk drive, a magnetic disk drive, an optical disk drive, USB drive, or any computer program product configured to store data and machine executable program code. According to certain examples or implementations, the memory 820 or mass storage 850 may have recorded thereon statements and instructions executable by the processor 810 for performing any of the aforementioned method operations described above.

Network interface 830 may include at least one of a wired network interface and a wireless network interface. The network interface 830 may include a wired network interface to connect to a communication network 880 and may also include a radio access network interface 890 for connecting to the communication network 880 or other network elements over a radio link. The network interface 830 enables the electronic device 800 to communicate with remote entities such as those connected to the communication network 880.

It will be appreciated that, although specific examples or implementations of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding examples or implementations, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the examples or implementations of the present invention. For example, such an execution may correspond to a simulation of the logical operations as described herein. The software product may additionally or alternatively include number of instructions that enable a computer device to execute operations for configuring or programming a digital logic apparatus in accordance with examples or implementations of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise. The phrase “at least one” means one or more, and “a plurality of” means two or more. In addition, “and/or” describes an association relationship of associated objects, and indicates that there may be three relationships. For example, A and/or B may indicate cases including “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent “a”, “b”, “c”, “a and b”, “a and c”, “b and c”, or “a, b and c”, where a, b, and c may be a single or multiple form.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated examples or implementations, not all of them need to be combined to realize the benefits of various examples or implementations of this disclosure. In other words, a system or method designed according to an example or implementation of this disclosure will not necessarily include all features shown in any one of the Figures or all portions schematically shown in the Figures. Moreover, selected features of one example or implementation may be combined with selected features of other examples or implementations.

Although the present invention has been described with reference to specific features and examples or implementations thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising:
receiving, by a radio frequency (RF) antenna unit of a first electronic device (FED), a RF signal from a second electronic device (SED), the RF signal having associated thereto an angle of arrival (AOA) at the FED;
aiming a light source of the FED towards the SED in accordance with the AOA of the RF signal;
and
transmitting, by the light source, an optical signal towards the SED, the optical signal encoding a data message.

2. The method of claim 1 wherein:
the FED has a control unit;
and
the method further comprises:
determining, by the control unit, the AOA.

3. The method of claim 2 wherein:
the RF antenna unit includes a plurality of antennae arranged as an array of antennae;
receiving, by the RF antenna unit of the FED, the RF signal from the SED includes:
receiving, by each antenna of the array of antennae, the RF signal, the RF signal having a respective phase shift at each antenna;
and
determining, by the control unit, the AOA includes:
determining, by the control unit, the AOA in accordance with the respective phase shift of each antenna of the array of antennae.

4. The method of claim 2 wherein determining, by the control unit, the AOA includes:
determining, by the control unit, the AOA in accordance with a multiple signal classification algorithm.

5. The method of claim 1 further comprising:
establishing, by the RF antenna unit, a RF link with the SED.

6. The method of claim 1 wherein transmitting, by the light source, the optical signal towards the receiving electronic device includes:
sweeping the light source through a sweep pattern oriented in accordance with the AOA of the RF signal.

7. The method of claim 1 further comprising:
receiving, by the RF antenna unit, a further RF signal from the SED, the further RF signal defining an alignment offset;
re-aiming the light source towards the SED in accordance with the alignment offset;
and
transmitting, by the light source, a further optical signal towards the SED, the further optical signal encoding the data message.

8. The method of claim 1 wherein the light source is a free-space laser.

9. The method of claim 1 wherein at least one of the SED and the FED is a satellite.

10. The method of claim 1 wherein each of the light source and the RF antenna unit are co-located at the FED.

11. A method comprising:
receiving, by a light detector of a first electronic device (FED), an optical signal from a second electronic device (SED), the optical signal encoding a data message and having associated thereto a first detected power and an alignment offset;
transmitting, by a radio frequency (RF) antenna unit of the FED, a RF signal towards the SED, the RF signal encoding the alignment offset;
and
receiving, by the light detector, a further optical signal from the SED, the further optical signal encoding the data message and having associated thereto a second detected power being greater than the first detected power.

12. The method of claim 11 further comprising:
establishing, by the RF antenna unit, a RF link with the SED.

13. The method of claim 11 wherein:
the light detector includes a main light sensor and one or more auxiliary light sensors each separated from the main light sensor;
and
receiving, by the light detector, the optical signal from the SED includes:
receiving, by the main light sensor, a main light sensor portion of the optical signal having a respective optical power;
and
receiving, by each of the one or more auxiliary light sensors, a respective auxiliary light sensor portion of the optical signal having a respective auxiliary optical power.

14. The method of claim 13 wherein:
the FED has a control unit;
and
the method further comprises:
determining, by the control unit, the alignment offset in accordance with the respective optical power of the main light sensor portion of the optical signal and the respective auxiliary optical power of each auxiliary light sensor portion of the optical signal.

15. The method of claim 13 wherein the main light sensor is located about at a first predetermined vector with respect to the RF antenna unit and each of the one or more auxiliary light sensors is located about at a respective second predetermined vector with respect to the main light sensor.

16. The method of claim 11 wherein at least one of the FED and the SED is a satellite.

17. A system for communicating a data message comprising:
a first electronic device (FED);
and
a second electronic device (SED) having a light source and a respective radio-frequency (RF) antenna unit, the SED configured to:
receive, by the respective RF antenna unit, a RF signal from the FED, the RF signal having associated thereto an angle of arrival (AOA) at the SED;
aim the light source towards the FED in accordance with the AOA of the RF signal;
and
transmit, by the light source, an optical signal towards the FED, the optical signal encoding the data message.

18. The system of claim 17 wherein:
the FED has a light detector and a respective RF antenna unit;
and
the FED is configured to:
receive, by the light detector, the optical signal from the SED, the optical signal having associated thereto an alignment offset;
and
transmit, by the respective RF antenna unit, a further RF signal towards the SED, the RF signal encoding the alignment offset.

19. The system of claim 18 wherein:
the SED is further configured to:
receive, by the respective RF antenna unit, the further RF signal from the FED;
re-aim the light source towards the FED in accordance with the alignment offset;
and
transmit, by the light source, a further optical signal towards the FED, the further optical signal encoding the data message.

20. The system of claim 19 wherein:
the FED is further configured to:
receive, by the light detector, the further optical signal from the SED, the further optical signal having associated thereto a respective detected power being greater than the respective detected power of the optical signal.
